(19) United States
(12) Patent Application Publication
(10) Pub. No.: US 2007/0230890 A1
(43) Pub. Date: Oct. 4, 2007

(54) Packaging method of optical fiber and optical fiber

(75) Inventors: Hiroshi Oyamada, Gunma (JP); Dai Inoue, Gunma (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Shin-Etsu Chemical Co., Ltd., Tokyo (JP)

(21) Appl. No.: 11/639,132

(22) Filed: Dec. 15, 2006

(30) Foreign Application Priority Data
Dec. 16, 2005 (JP) 2005-363805
Dec. 8, 2006 (JP) 2006-332353

(51) Int. Cl. G02B 6/00

(52) U.S. Cl. 385/135

(57) ABSTRACT

There is provided a packaging method of an optical fiber capable of performing a heavy hydrogen treatment during packing and storing easily and at low cost without a conventional grand processing apparatus. The packaging method includes: receiving an optical fiber 1 wound on an optical fiber bobbin 5 within a packing material 2 having flexibility to seal an opening part, sealing up the packing material 2 after introducing heavy hydrogen, and performing a heavy hydrogen treatment on the optical fiber 1 in a mixed gas atmosphere containing heavy hydrogen and air during storing and transporting the optical fiber 1. At this time, concentration of heavy hydrogen within the packing material 2 just after enclosing heavy hydrogen is within a range of 0.5 ppm to 4%. The opening part 3 of the packing material 2 may be sealed with heat or an adhesive after receiving the optical fiber 1, or may be sealed with a zipper. Moreover, the introduction of heavy hydrogen may be performed from the remained opening part 3 after sealing the opening part as a part of the opening part remains, or may be performed from an opening part having a self-sealed check valve 6 provided in the packing material 2.

### BACKGROUND

1. Field of the Invention

The present invention relates to a packaging method of an optical fiber suitable for obtaining an optical fiber consisting primarily of silica glass, more particularly a low OH-peak optical fiber (hereinafter, abbreviated as “an LWP (low water peak) optical fiber”) obtained by reducing loss around light wavelength 1383 nm. The present application relates to and claims priority from a Japanese Patent Applications No. 2005-363805 filed in Japan on Dec. 16, 2005 and No. 2006-332353 filed in Japan on Dec. 8, 2006, the contents of which are incorporated herein by reference for all purpose if applicable in the designated state.

2. Related Art

An optical fiber is usually manufactured by means of so-called drawing performed by heating/fusing/elongating a base material for optical fiber consisting of bar-type silica glass to prolong the base material to predetermined size (for example, Φ125 μm).

In the optical fiber according to a drawing process, extremely a part of bonding between atoms in glass may be cut by heating and tensile force and be solidified in a state that defects have been produced. In particular, NBOHC (a non-bridging oxygen hole center) defects having “≡Si—O.” structure may remain. The defects instantly catch hydrogen and then is changed into “≡Si—O—H” when hydrogen is diffused in glass. Since this “≡Si—O—H” absorbs light around 1383 nm, there is a problem that absorption loss by OH around 1383 nm increases.

In particular, since an LWP fiber reacts on hydrogen of about 0.5 ppm in the atmosphere and hydrogen (usually, around 0.4%, see Shimizu et al., “Hydrogen Aging Teats for Optical Fibers”, 50th IWCS Proceedings, pp. 219-223 (2001)) generated in a duct in an optical fiber cable and thus loss increases around 1383 nm, there is a problem that the fiber is not a LWP fiber substantially.

In order to prevent this, a method for previously performing a heavy hydrogen treatment on an optical fiber after drawing to remove NBOHC has been proposed as disclosed in Japanese Patent Application Publication 2002-148450. This method is a technique for exposing the optical fiber to an atmosphere containing heavy hydrogen, reacting heavy hydrogen diffused in the optical fiber with defects such as NBOHC, and then removing heavy hydrogen remaining in a neutral atmosphere. This method prevents NBOHC and hydrogen from being coupled with each other by previously reacting NBOHC with heavy hydrogen.

However, in a conventional method, mixed gas is introduced after the mixed gas containing a predetermined amount of heavy hydrogen is prepared and an optical fiber is accommodated in a closed system. After a heavy hydrogen treatment, unnecessary heavy hydrogen is removed by introducing neutral gas such as inert gas in an apparatus. After that, the optical fiber is fetched from the apparatus, and is packed and shipped. In this manner, there has been a problem that a grand apparatus is required in order to process heavy hydrogen in an optical fiber.

### SUMMARY

The present invention has been achieved in view of the situation above, and the object is to provide a packaging method of an optical fiber capable of easily performing a heavy hydrogen treatment on the optical fiber during package storage at low cost without requiring a conventional grand processing apparatus.

As a result of superimposed researches in order to solve this object, this inventors has completed this invention through an effect similar to that obtained by processing an optical fiber in a grand heavy hydrogen processing apparatus by receiving the optical fiber in a packing material capable of being substantially sealed and easily treated and introducing heavy hydrogen when the optical fiber obtained by drawing a base material for optical fiber is kept in a storeroom.

That is, a packaging method of the present invention includes: receiving an optical fiber wound on an optical fiber bobbin within a packing material having flexibility to seal an opening part; sealing up the packing material after introducing heavy hydrogen; and performing a heavy hydrogen treatment on the optical fiber in a mixed gas atmosphere containing heavy hydrogen and air during storing and transporting the optical fiber. At this time, it is preferable that concentration of heavy hydrogen within the packing material just after enclosing heavy hydrogen is within a range of 0.5 ppm to 4%. Moreover, it is further preferable that concentration of heavy hydrogen within the packing material is within a range of 0.1% to 1%.

The opening part of the packing material may be sealed with heat or an adhesive after receiving the optical fiber, or may be sealed with a zipper. Moreover, the introduction of heavy hydrogen may be performed from the remained opening part after sealing the opening part as a part of the opening part remains, or may be performed from an opening part having a self-sealed check valve provided in the packing material.

According to the present invention, a grand processing apparatus for processing an optical fiber, which has been conventionally required, can be simplified and further the preparation of special mixed gas and special degasification work are not required. Moreover, since a heavy hydrogen treatment is substantially performed during the storage and transportation of optical fiber by receiving and sealing the optical fiber in a packing material in a normal atmosphere and then injecting heavy hydrogen by a predetermined amount to set heavy hydrogen concentration within the packing material to a predetermined concentration, a heavy hydrogen treatment has been substantially completed when the optical fiber is opened after a predetermined time and thus the invention has an advantage that the optical fiber can be opened in the atmosphere to be used promptly.

### BRIEF DESCRIPTION OF THE DRAWINGS

FIG. 1 is a perspective view exemplary explaining a packaging method of an optical fiber of the present invention.

FIG. 2 is a graph showing relation between a wavelength and loss of an optical fiber.

FIG. 3 is a graph showing relation between processing days and a peak value of loss by NBOHC.

### DESCRIPTION OF EXEMPLARY EMBODIMENTS

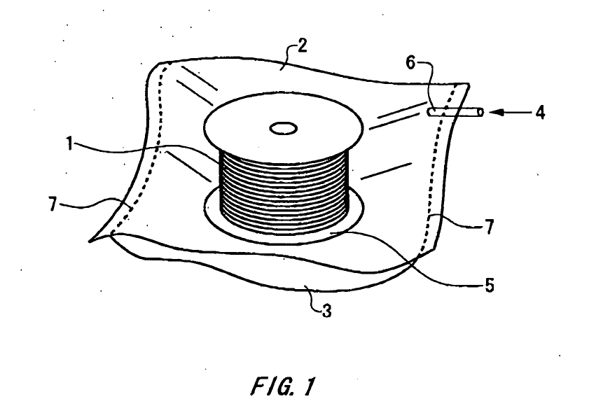

Hereinafter, it will be explained in detail about a packaging method of an optical fiber according to the present invention with reference to the attached drawings. A base material for optical fiber is heated, melted, and prolonged to form an optical fiber 1, and the optical fiber 1 is wound on an optical fiber bobbin 5. The optical fiber 1 wound on the optical fiber bobbin 5 is immediately accommodated in a packing material 2 and is sealed (see FIG. 1). The packing material 2 includes an opening part 3 for receiving the optical fiber, which can be sealed, and an opening part 4 for introducing gas. In addition, the opening part 3 can be substituted for the opening part 4 for introducing gas.

When winding the optical fiber ion the optical fiber bobbin 5, the optical fiber 1 may be wound so as to have predetermined tension.

Heavy hydrogen is introduced into the packing material 2 in which the optical fiber bobbin 5 is accommodated and sealed, in order to seal the packing material 2 as a mixed gas atmosphere containing heavy hydrogen and air. At this time, an amount of enclosure of heavy hydrogen is within a range of 0.5 ppm to 4% as heavy hydrogen concentration. It is preferable that a sealing means of the opening part 3 for receiving the optical fiber is to heat and seal the packing material 2 with resin having flexibility, or to seal the packing material 2 with a zipper. In addition, it is desirable to highly set concentration of heavy hydrogen just after enclosing heavy hydrogen within the above range when sealing the opening part 3 with a zipper. Moreover, the opening part 4 for introducing gas may include a self-sealed check valve 6 therein to be sealed by differential pressure between inside and outside of the packing material 2.

Inert gas such as nitrogen, helium, and argon may be used as gas mixed with heavy hydrogen within the packing material 2 instead of the atmosphere.

According to the present invention, a heavy hydrogen treatment for the optical fiber 1 is performed during shipment/transport by receiving the optical fiber bobbin 5 in the packing material 2, injecting heavy hydrogen by a predetermined amount, and setting heavy hydrogen concentration within the packing material 2 to 0.5 ppm to 4%. Generally, the heavy hydrogen treatment has been substantially completed after several days or one month, the optical fiber 1 can be opened in the atmosphere and be promptly used. For this reason, a grand degasification apparatus is unnecessary.

NBOHC in the optical fiber 1 is an amount of high ppb order. For this reason, for example, an amount of heavy hydrogen required for processing the optical fiber 1 with Φ125 μm and a length of 25 km is sufficiently about 0.0005 mL.

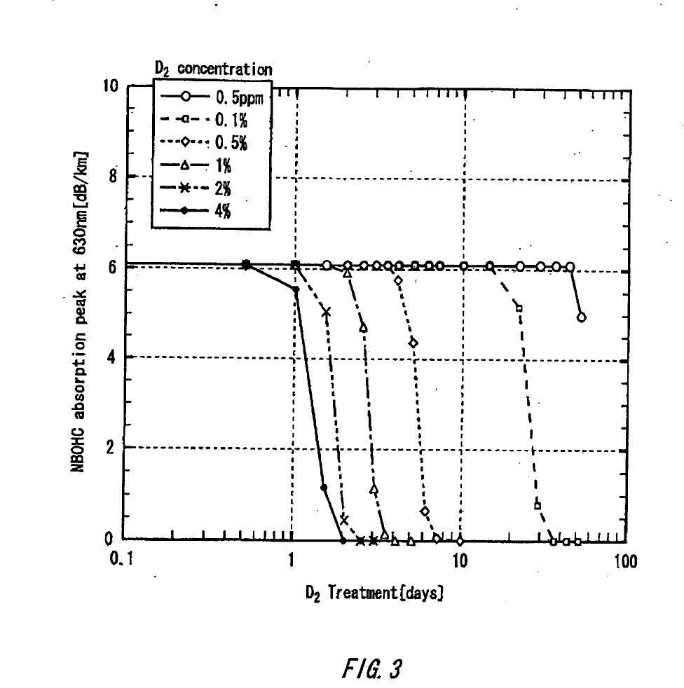

FIG. 3 shows a graph obtained by plotting relation between processing days and a peak value of loss by NBOHC using heavy hydrogen concentration as a parameter. It is known that a NBOHC defect has a peak of absorption loss around light wavelength 630 nm. Therefore, a reduction of NBOHC defect by processing with the heavy hydrogen can be identified as a reduction of the peak of absorption loss at 630 nm.

Since heavy hydrogen concentration within the packing material 2 is quantitatively close to hydrogen concentration in the atmosphere when the heavy hydrogen concentration is less than 0.5 ppm, the effect is thin. Moreover, although there is an effect when the heavy hydrogen concentration is below 0.1%, it is required to perform a heavy hydrogen treatment for about one month. Otherwise, since there is the danger of ignition during opening when the heavy hydrogen concentration exceeds 4%, it is not appropriate. Moreover, the heavy hydrogen treatment is performed for a period before or after few days even when the heavy hydrogen concentration exceeds 1%, and this does not have the difference in comparison with the case when the heavy hydrogen concentration exceeds 4% and uneconomically leaves un-reacting heavy hydrogen in large amounts. Therefore, the heavy hydrogen concentration within the packing material 2 is within a range of 0.5 ppm to 4%, preferably, 0.1 to 1%.

A material of the packing material 2 includes, for example, soft vinyl chloride resin, olefinic resin, other hard plastics, metal foil, and so on, and particularly includes soft vinyl chloride resin. Since soft vinyl chloride resin can be provided at comparatively cheap cost, it is a preferable material in view of cost. Although heavy hydrogen gets away through the packing material 2 bit by bit when using soft vinyl chloride resin, it is not a cause for concern because high concentration is kept for around one month. In addition, when heavy hydrogen gets away through the packing material 2, it is preferable to early raise heavy hydrogen concentration according to transparency of the used packing material 2.

Moreover, a handle for transportation may be *attached to the packing material 2 if required. Furthermore, although the optical fiber 1 received in the packing material 2 may be shipped and transported as it is, the optical fiber 1 may be packed in a further hard vessel if required.

### Embodiment

The optical fiber 1 has been packed by means of the packing material 2 made of soft vinyl chloride resin as shown in FIG. 1. The optical fiber 1 wound on the optical fiber bobbin 5 is received in the packing material 2 after a predetermined inspection, and the opening part 3 thereof is heated and sealed. This packing work is performed in the normal atmosphere, and air with atmospheric pressure of about 10 L enters into the packing material 2. In addition, the optical fiber bobbin 5 is a tubular type with a diameter of about 20 cm and a height of about 12 cm, and the optical fiber with Φ125 μm and a length of 25 km is wound on the bobbin.

Next, heavy hydrogen of 100 mL is introduced into the packing material 2 from the opening part 4 for introducing gas. Heavy hydrogen is diffused into the packing material 2, and a mixed gas atmosphere with air to be heavy hydrogen concentration of about 1% is formed. The self-sealed check valve 6 used for a mattress compressing bag or the like is attached to the opening part 4 for introducing gas, and thus the inside of the packing material 2 is substantially sealed. The optical fiber 1 packed in this way can be transported and stored as it is or as it is packed in a hard vessel, and the optical fiber 1 is processed by heavy hydrogen during this period. When opening the packing material 2 after one week and measuring heavy hydrogen concentration of gas discharged from the packing material 2, it is about 0.8% and the weight loss of heavy hydrogen is slight for this one week.

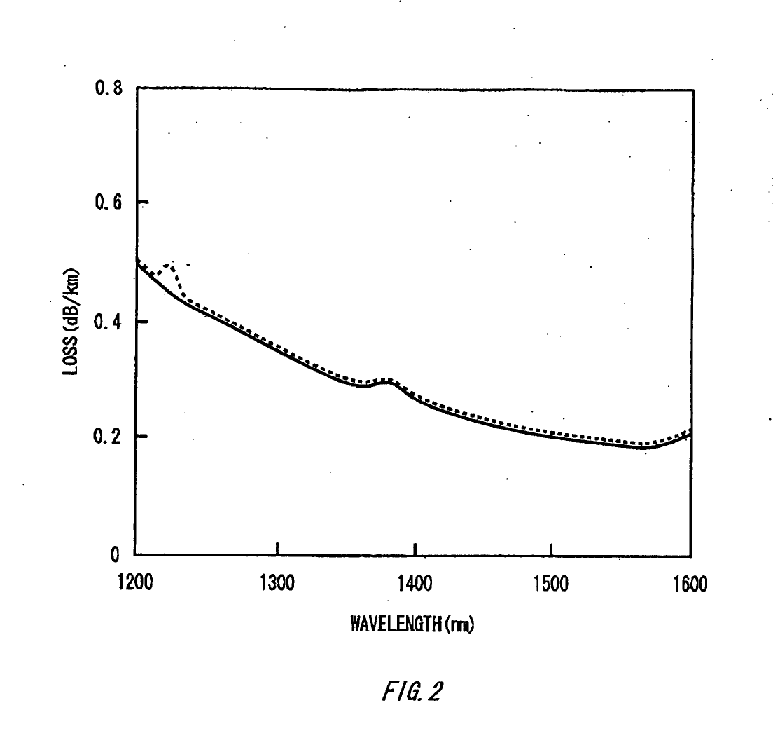

FIG. 2 shows a wavelength-loss curved line obtained by measuring loss of the optical fiber 1 processed by this heavy hydrogen. In the present drawing, a curved line shown with a solid line is obtained by measuring loss after one week from packing, and a curved line shown with a dashed line is obtained by measuring loss after further exposing the optical fiber 1 to hydrogen of 0.01 atmosphere for four days. As is apparent from the comparison of both curved lines, since the increase of loss around 1383 nm by hydrogen is not accepted, a packaging method of the present invention can easily reduce loss around 1383 nm that is considered as a conventional shortcoming

According to the present invention, since a grand processing apparatus for processing an optical fiber, which has been conventionally required, is simplified and the preparation of special mixed gas and a special degasification apparatus are required, the invention extremely has advantage in view of cost and thus industrial applicability is extremely high.

What is claimed is:

1. A packaging method of an optical fiber, comprising:
receiving the optical fiber wound on an optical fiber bobbin within a packing material having flexibility to seal an opening part;
sealing up the packing material after introducing heavy hydrogen; and
performing a heavy hydrogen treatment on the optical fiber in a mixed gas atmosphere containing heavy hydrogen and air during storing and transporting the optical fiber.

2. The packaging method of the optical fiber as claimed in claim 1, wherein concentration of heavy hydrogen within the packing material just after enclosing heavy hydrogen is within a range of 0.5 ppm to 4%.

3. The packaging method of the optical fiber as claimed in claim 1, wherein concentration of heavy hydrogen within the packing material just after enclosing heavy hydrogen is within a range of 0.1% to 1%.

4. The packaging method of the optical fiber as claimed in claim 1, wherein the opening part is sealed with a zipper.

5. The packaging method of the optical fiber as claimed in claim 1, wherein the introduction of heavy hydrogen is performed from the opening part.

6. The packaging method of the optical fiber as claimed in claim 1, wherein the introduction of heavy hydrogen is performed from an opening part having a self-sealed check valve provided in the packing material.

7. An optical fiber that is sealed in a packing material having flexibility along with mixed gas containing heavy hydrogen and air.

8. The optical fiber as claimed in claim 7, wherein concentration of heavy hydrogen in the mixed gas is within a range of 0.5 ppm to 4%.

9. The optical fiber as claimed in claim 7, wherein concentration of heavy hydrogen in the mixed gas is within a range of 0.1% to 1%.
